(19) United States
(12) Patent Application Publication
(10) Pub. No.: US 2003/0108784 A1
(43) Pub. Date: Jun. 12, 2003

(54) Fuel cell system for use in vehicles

(75) Inventors: Naoyuki Enjoji, Utsunomiya-shi (JP); Masaharu Suzuki, Utsunomiya-shi (JP); Hideaki Kikuchi, Kawachi-gun (JP)

Correspondence Address: LAHIVE & COCKFIELD, 28 STATE STREET, BOSTON, MA, 02109, US

(73) Assignee: Honda Giken Kogyo Kabushiki Kaisha, Tokyo (JP)

(21) Appl. No.: 10/313,509

(22) Filed: Dec. 6, 2002

(30) Foreign Application Priority Data
Dec. 6, 2001 (JP) 2001-373275

(51) Int. Cl. H01M 8/02; H01M 8/04

(52) U.S. Cl. 429/34; 429/26

(57) ABSTRACT

A fuel cell stack is mounted in a front box of a fuel cell vehicle. The fuel cell stack has a vertical stack of unit cells. The number of unit cells is increased to produce a higher output from the fuel cell stack. For a higher output from the fuel cell stack, therefore, the fuel cell stack is elongated only in the vertical direction, and does not increase its dimension in either a longitudinal direction or a transverse direction of the fuel cell vehicle.

### BACKGROUND OF THE INVENTION

1. Field of the Invention

The present invention relates to a fuel cell system mounted on a front box of a vehicle.

2. Description of the Related Art

For example, a solid polymer electrolyte fuel cell employs a membrane electrode assembly (MEA) which comprises two electrodes (anode and cathode) and an electrolyte membrane interposed between the electrodes. The electrolyte membrane is a polymer ion exchange membrane (proton exchange membrane). The membrane electrode assembly is interposed between separators.

The membrane electrode assembly and the separators make up a unit of the fuel cell for generating electricity. A plurality of fuel cells are connected together to form a fuel cell stack. In the fuel cell stack, a fuel gas such as a hydrogen-containing gas is supplied to the anode. The catalyst of the anode induces a chemical reaction of the fuel gas to split the hydrogen molecule into hydrogen ions (protons) and electrons. The hydrogen ions move toward the cathode through the electrolyte, and the electrons flow through an external circuit to the cathode, creating a DC electric current. An oxygen-containing gas or air is supplied to the cathode. At the cathode, the hydrogen ions from the anode combine with the electrons and oxygen to produce water.

There is known a fuel cell system where the above fuel cell stack is incorporated in a front box of a vehicle (see U.S. Pat. No. 5,662,184). According to the disclosed fuel cell system, as shown in FIG. 11 of the accompanying drawings, a radiator 3 is disposed in a front box 2 of a vehicle body 1 at a front end thereof in the direction indicated by the arrow X in which the vehicle body 1 is normally propelled, and front wheels 5 are rotatably supported by front axles 6 and positioned outside of a vehicle frame 4.

The front axles 6 are rotated by a motor 7 which is supplied with electric energy from a pair of fuel cell stacks 8. The fuel cell stacks 8 are disposed one on each side of a compressor 9 for supplying an oxygen-containing gas and positioned inside the vehicle frame 4. Although not shown, a fuel tank, a fuel reformer, and a compressor for supplying a fuel gas are disposed on a rear side (trunk) of the vehicle body 1.

In the conventional fuel cell system, each of the fuel cell stacks 8 comprises a plurality of unit cells 8a stacked in the horizontal direction, i.e., in the direction indicated by the arrow X. If the number of unit cells 8a is increased to produce a higher output from the fuel cell stacks 8, then the fuel cell stacks 8 have their longitudinal dimension increased toward the radiator 3 as indicated by the two-dot-and-dash lines in FIG. 11. In such a situation, the front box 2 needs to be expanded in the direction indicated by the arrow X to prevent the fuel cell stacks 8 from being damaged by external shocks applied to the vehicle body 1. As a result, the vehicle body 1 has its full length increased.

One solution would be to stack the unit cells 8a in the transverse direction, i.e., in the direction indicated by the arrow Y, in each of the fuel cell stacks 8. However, if the number of unit cells 8a is increased to produce a higher output from the fuel cell stacks 8, then the fuel cell stacks 8 are elongated in the transverse direction of the vehicle body 1, resulting in an increase in the full width of the vehicle body 1. For the above reasons, the full length and/or full width of the vehicle body 1 changes when efforts are made to produce a higher output from the fuel cell stacks 8.

### SUMMARY OF THE INVENTION

It is a major object of the present invention to provide a fuel cell system which includes fuel cell stacks mounted neatly in a front box of a vehicle and is capable of producing a higher output without involving dimensional changes of the vehicle.

According to the present invention, a fuel cell stack has alternately stacked electrolyte electrode assemblies and separators. Each of the electrolyte electrode assemblies comprises a pair of electrodes and an electrolyte disposed between the electrodes. The fuel cell stack is disposed in a front box of a vehicle with said electrolyte electrode assemblies and said separators being stacked vertically. Therefore, when the number of stacked electrolyte electrode assemblies and separators is increased to produce a higher output from the fuel cell stack, the fuel cell stack is elongated only vertically, but not in a longitudinal direction or a transverse direction of the vehicle.

Therefore, the fuel cell stack can easily be arranged for a higher output without the need for changing the full length or width of the vehicle. Since the fuel cell stack is expanded only in the vertical direction, various accessories can be placed in a neat layout in the front box while achieving a higher output from the fuel cell stack.

A radiator is disposed in the front box at a front end thereof in the direction in which the vehicle is normally propelled, and coolant supply accessories for supplying a coolant to the fuel cell stack are disposed between the radiator and the fuel cell stack. The coolant supply accessories and the radiator are disposed closely to each other for effectively cooling coolant pipes with cool air. A cooling system is thus simplified in arrangement, and a space utilization efficiency is increased. Since the coolant pipes are relatively short, the amount of charged coolant is reduced, the pressure loss caused by the coolant pipes is lowered, and the cooling system is made lightweight.

Fuel gas supply accessories for supplying a fuel gas to the fuel cell stack are disposed on one side of the fuel cell stack with respect to the direction in which the vehicle is normally propelled. Consequently, the fuel gas supply accessories are not susceptible to external shocks, and are reliably protected against damage due to such external shocks.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a fuel cell system according to a first embodiment of the present invention;

FIG. 2 is an exploded perspective view of a portion of a fuel cell stack of the fuel cell system according to the first embodiment;

FIG. 3 is a schematic plan view of a fuel cell vehicle which incorporates the fuel cell system;

FIG. 4 is a schematic side elevational view of the fuel cell vehicle;

FIG. 5 is a schematic plan view of a fuel cell vehicle which incorporates a fuel cell system according to a second embodiment of the present invention;

FIG. 6 is a schematic plan view of a fuel cell vehicle which incorporates a fuel cell system according to a third embodiment of the present invention;

FIG. 7 is a schematic plan view of a fuel cell vehicle which incorporates a fuel cell system according to a fourth embodiment of the present invention;

FIG. 8 is a schematic plan view of a fuel cell vehicle which incorporates a fuel cell system according to a fifth embodiment of the present invention;

FIG. 9 is a schematic side elevational view of a fuel cell vehicle which incorporates a fuel cell system according to a sixth embodiment of the present invention;

FIG. 10 is a schematic plan view of a fuel cell vehicle which incorporates a modification of the fuel cell system according to the first embodiment, which includes two fuel cell stacks; and

FIG. 11 is a schematic plan view of a fuel cell vehicle which incorporates a conventional fuel cell system.

### DESCRIPTION OF THE PREFERRED EMBODIMENTS

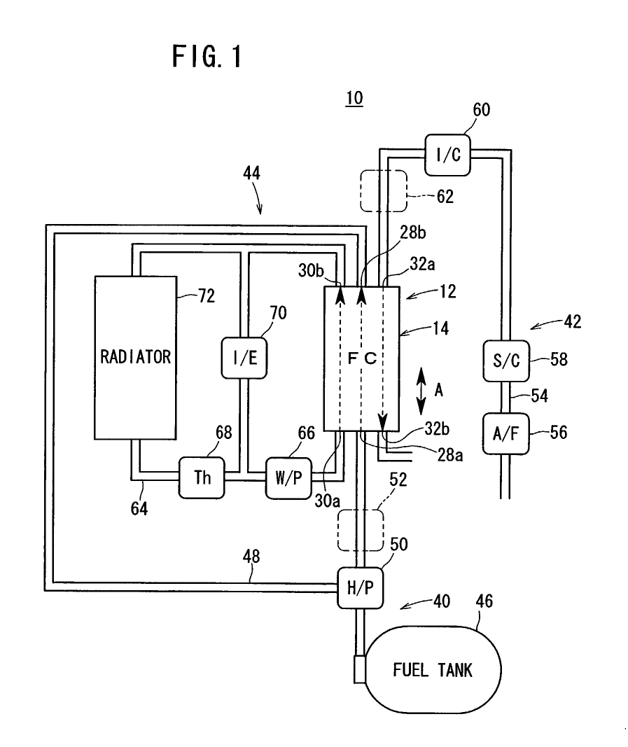

FIG. 1 shows in block form a fuel cell system 10 according to a first embodiment of the present invention.

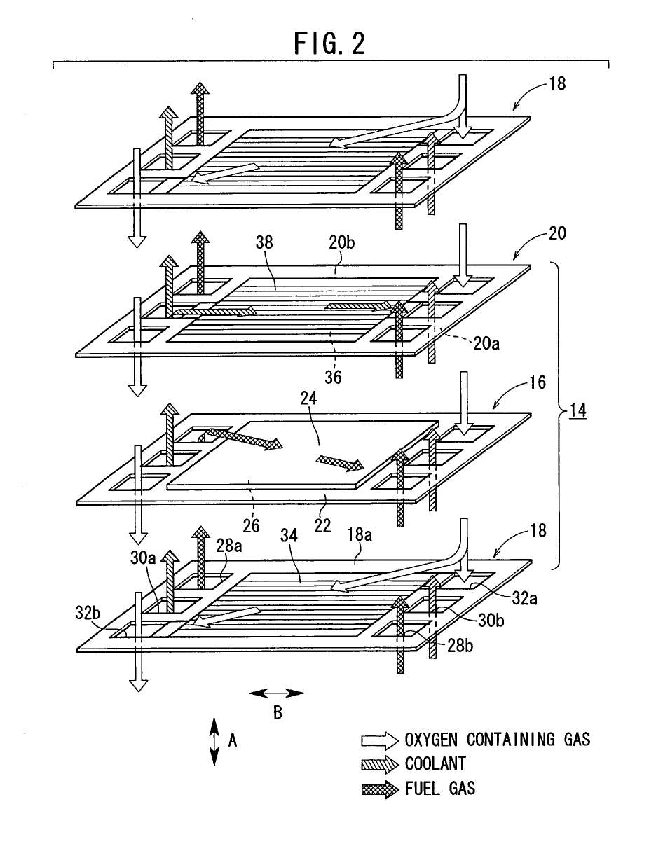

As shown in FIG. 1, the fuel cell system 10 has a fuel cell stack 12 comprising a predetermined number of unit cells 14 stacked in the vertical direction, i.e., in the direction indicated by the arrow A. As shown in FIG. 2, each of the unit cells 14 comprises a membrane electrode assembly (electrolyte electrode assembly) 16 and first and second separators 18, 20 sandwiching the membrane electrode assembly 16 therebetween.

The membrane electrode assembly 16 comprises a solid polymer electrolyte membrane 22, an anode electrode 24 disposed on one surface of the solid polymer electrolyte membrane 22, and a cathode electrode 26 disposed on the other surface of the solid polymer electrolyte membrane 22. Each of the anode electrode 24 and the cathode electrode 26 comprises an electrode catalyst layer of precious metal and a gas diffusion layer as a porous layer made of porous carbon paper, for example, the electrode catalyst layer being joined to the gas diffusion layer.

The unit cell 14 has, defined in one longitudinal end thereof (in the direction indicated by the arrow B), a fuel gas supply communication hole 28a, a coolant supply communication hole 30a, and an oxygen-containing gas discharge communication hole 32b, and also has, defined in the other longitudinal end thereof, an oxygen-containing gas supply communication hole 32a, a coolant discharge communication hole 30b, and a fuel gas discharge communication hole 28b.

Each of the first and second separators 18, 20 is made of thin metal sheet or thin carbon sheet. The first separator 18 has, defined in a surface 18a facing the cathode electrode 26, a plurality of oxygen-containing gas passage grooves 34 which are held in communication with the oxygen-containing gas supply communication hole 32a and the oxygen-containing gas discharge communication hole 32b. The second separator 20 has, defined in a surface 20a facing the anode electrode 24, a plurality of fuel gas passage grooves 36 which are held in communication with the fuel gas supply communication hole 28a and the fuel gas discharge communication hole 28b. The second separator 20 has, defined in a surface 20b facing another first separator 18, a plurality of coolant passage grooves 38 which are held in communication with the coolant supply communication hole 30a and the coolant discharge communication hole 30b.

As shown in FIG. 1, the fuel cell stack 12 is combined with a fuel gas supply 40 for supplying a fuel gas such as a hydrogen-containing gas, an oxygen-containing gas supply 42 for supplying an oxygen-containing gas such as air, and a coolant supply 44 for supplying a coolant such as pure water, ethylene glycol, oil, or the like.

The fuel gas supply 40 has a fuel tank 46 communicating with the fuel gas supply communication hole 28a and the fuel gas discharge communication hole 28b in the fuel cell stack 12 through a fuel gas circulation passageway 48. The fuel gas circulation passageway 48 has a fuel gas pump (H/P) 50 and also has a humidifier 52, if necessary.

The oxygen-containing gas supply 42 has an oxygen-containing gas supply passageway 54 communicating with the oxygen-containing gas supply communication hole 32a in the fuel cell stack 12. The oxygen-containing gas supply passageway 54 has an air filter (A/F) 56, a supercharger (S/C) 58, and an intercooler (I/C) 60, and also has a humidifier 62, if necessary.

The coolant supply 44 has a coolant circulation passageway 64 communicating with the coolant supply communication hole 30a and the coolant discharge communication hole 30b in the fuel cell stack 12. The coolant circulation passageway 64 has a coolant pump (W/P) 66, a thermostat (Th) 68, an ion exchanger (I/E) 70, and a radiator 72.

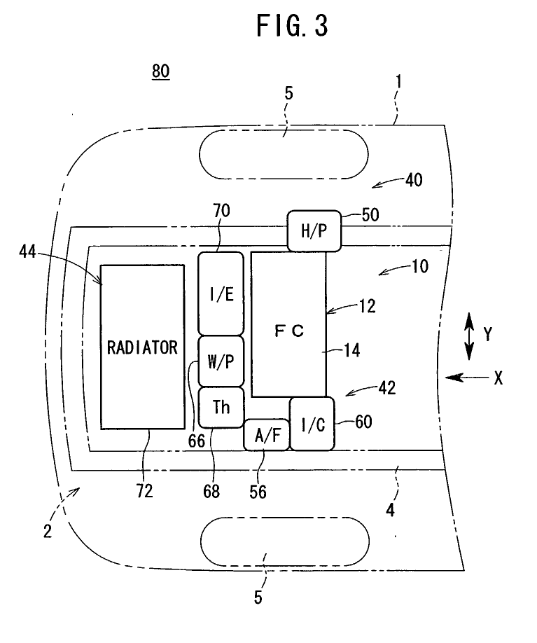

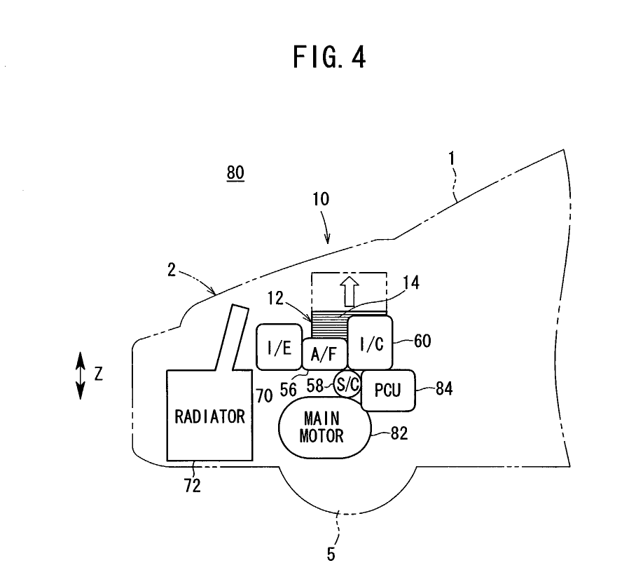

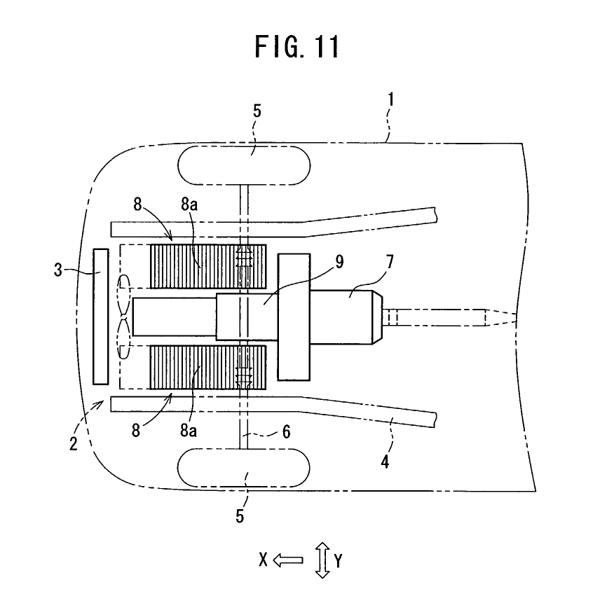

FIG. 3 schematically shows in plan a fuel cell vehicle 80 which incorporates the fuel cell system 10 described above. FIG. 4 schematically shows in side elevation the fuel cell vehicle 80 illustrated in FIG. 3. Those parts of the fuel cell vehicle 80 which are identical to the vehicle body 1 shown in FIG. 11 are denoted by identical reference characters, and will not be described in detail below.

The fuel cell stack 12 has the unit cells 14 stacked vertically in the direction indicated by the arrow R in FIG. 4 and housed in a front box 2. The front box 2 also houses the radiator 72 at a front end thereof in the direction indicated by the arrow X in FIG. 3 in which the fuel cell vehicle 80 is normally propelled. The fuel cell stack 12 has its longitudinal axis oriented transversely across the fuel cell vehicle 80, i.e., in the direction indicated by the arrow Y in FIG. 3. The coolant pump 66, the thermostat 68, and the ion exchanger 70 which serve as coolant supply accessories are closely positioned between the radiator 72 and the fuel cells tack 12.

The fuel gas pump 50, which is also a coolant supply accessory, is on one side of the fuel cell stack 12 with respect to the direction in which the fuel cell vehicle 80 is normally propelled, i.e., on one end of the fuel cell stack 12 in the transverse direction of the fuel cell vehicle 80, i.e., in the direction indicated by the arrow Y. The air filter 56, the intercooler 60, and the supercharger 58, which also serve as coolant supply accessories, are disposed near the other end of the fuel cell stack 12 (see FIGS. 3 and 4).

As shown in FIG. 4, a main motor 82 as a power source for applying drive power to front wheels 5 and/or rear wheels (not shown) is disposed closely below the fuel cell stack 12. The main motor 82 is supplied with electric energy from the fuel cell stack 12. A PCU (Power Control Unit) 84 is also disposed closely below the fuel cell stack 12. The PCU 84 serves to control the fuel cell system 10.

Operation of the fuel cell vehicle 80 in relation to the fuel cell system 10 according to the first embodiment will be described below.

As shown in FIG. 1, when the fuel gas pump 50 of the fuel gas supply 40 is actuated, the fuel gas such as a hydrogen-containing gas in the fuel tank 46 is supplied through the fuel gas circulation passageway 48 to the fuel cell stack 12. When the supercharger 58 of the oxygen-containing gas supply 42 is actuated, the oxygen-containing gas such as air is introduced from the air filter 56 through the oxygen-containing gas supply passageway 54. The oxygen-containing gas is cooled by the intercooler 60, and then supplied to the fuel cell stack 12.

When the coolant pump 66 of the coolant supply 44 is actuated, the coolant such as pure water, ethylene glycol, oil, or the like is supplied through the coolant circulation passageway 64 to the fuel cell stack 12.

As shown in FIG. 2, the fuel gas, the oxygen-containing gas, and the coolant are delivered into the fuel gas supply communication hole 28a, the oxygen-containing gas supply communication hole 32a, and the coolant supply communication hole 30a in the unit cells 14 of the fuel cell stack 12.

The fuel gas supplied to the fuel gas supply communication hole 28a is introduced into the fuel gas passage grooves 36 defined in the surface 20a of the second separator 20. The fuel gas moves along the anode electrode 24 of the membrane electrode assembly 16, and is then discharged into the fuel gas discharge communication hole 28b.

The oxygen-containing gas supplied to the oxygen-containing gas supply communication hole 32a is introduced into the oxygen-containing gas passage grooves 34 defined in the surface 18a of the first separator 18. The oxygen-containing gas moves along the cathode electrode 26 of the membrane electrode assembly 16, and is then discharged into the oxygen-containing gas discharge communication hole 32b.

In the membrane electrode assembly 16, the oxygen-containing gas supplied to the cathode electrode 26 and the fuel gas supplied to the anode electrode 24 are consumed by an electrochemical reaction in the electrode catalyst, generating electric energy. The generated electric energy is supplied to the main motor 82, which rotates the front wheels 5, for example.

The coolant supplied to the coolant supply communication hole 30a flows in and along the coolant passage grooves 38 defined in the surface 20b of the second separator 20. The coolant cools the membrane electrode assembly 16, and is then discharged into the coolant discharge communication hole 30b.

As shown in FIGS. 3 and 4, the fuel cell stack 12 with the unit cells 14 stacked vertically in the direction indicated by arrow Z is housed in the front box 2. If the number of unit cells 14 is increased for producing a higher output from the fuel cell stack 12, the fuel cell stack 12 is elongated only in the vertical direction as indicated by the two-dot-and-dash lines in FIG. 4.

Therefore, the fuel cell stack 12 is not elongated in the longitudinal direction (indicated by the arrow X) of the fuel cell vehicle 30 and the transverse direction (indicated by the arrow Y) of the fuel cell vehicle 30 even when the number of unit cells 14 is increased for producing a higher output from the fuel cell stack 12. According to the first embodiment, the output of the fuel cell stack 12 can easily be increased without the need for expanding the full length or width of the vehicle body 1. Since the fuel cell stack 12 is expended only vertically, the various accessories can neatly be laid out in the front box 2 while achieving a higher output from the fuel cell stack 12.

In the first embodiment, as shown in FIG. 3, the radiator 72 is positioned forward of the fuel cells tack 12, and the thermostat 68, the coolant pump 66, and the ion exchanger 70 which serve as coolant supply accessories are closely positioned transversely of the vehicle body 1 between the fuel cells tack 12 and the radiator 72.

Accordingly, the coolant supply 44 can be positioned in a concentrated layout as a whole, thus simplifying the cooling system and increasing the space utilization efficiency. As the coolant circulation passageway 64 is relatively short, the amount of coolant charged into the coolant circulation passageway 64 may be small. The pressure loss caused by the coolant circulation passageway 64 is reduced, and the coolant supply 44 is made lightweight.

In the first embodiment, the air filter 56, the super charger 58, and the intercooler 60, which serve as oxygen-containing gas supply accessories, are disposed closely to the fuel cell stack 12. The overall space utilization efficiency of the oxygen-containing gas supply 42 is increased, the oxygen-containing gas supply 42 is made highly responsive, and the pressure loss caused by the piping of the oxygen-containing gas supply 42 is reduced for increased electric energy generation efficiency.

The fuel gas pump 50 of the fuel gas supply 40 is disposed closely to one end of the fuel cell stack 12 in the transverse direction of the vehicle. Accordingly, even when an external shock is applied to the vehicle body 1, as the fuel gas pump 50 is positioned inward of one of the front wheels 5, the fuel gas pump 50 is reliably protected against damage caused by lateral shocks.

In the first embodiment, as shown in FIG. 4, the main motor 82 and the PCU 84 are disposed closely to the fuel cell stack 12. As a result, high-voltage three-phase wires connected to the main motor 82 and the PCU 84 are simplified, resulting in an increase in the space utility efficiency.

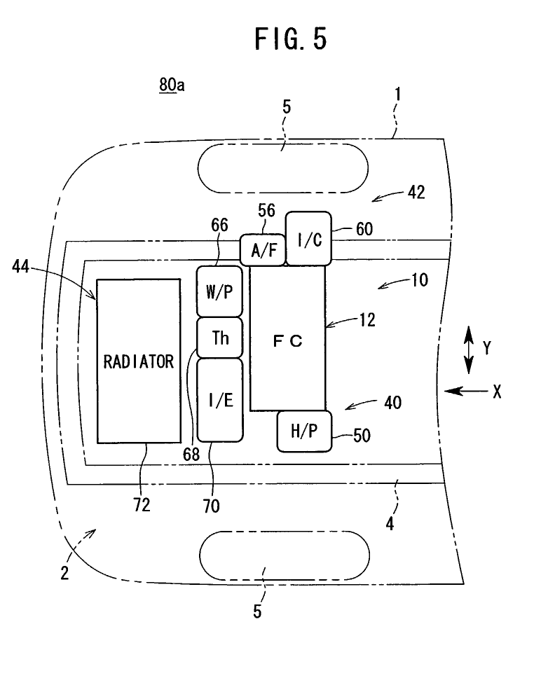

FIG. 5 schematically shows in plan a fuel cell vehicle 80a which incorporates a fuel cell system according to a second embodiment of the present invention. Those parts of the fuel cell vehicle 80a which are identical to the fuel cell vehicle 80 according to the first embodiment are denoted by identical reference characters, and will not be described in detail below. Those parts of fuel cell vehicles according to third through sixth embodiments to be described below which are identical to the fuel cell vehicle 80 according to the first embodiment are also denoted by identical reference characters, and will not be described in detail.

In the fuel cell vehicle 80a, the components of the coolant supply 44 disposed between the fuel cell stack 12 and the radiator 72 are arrayed in a sequence different from those of the coolant supply 44 on the fuel cell vehicle 80, and the fuel gas supply 40 and the oxygen-containing gas supply 42 are switched around on the opposite ends, transversely of the vehicle body 1, of the fuel cell stack 12, compared with those on the fuel cell vehicle 80.

Alternatively, only the components of the coolant supply 44 may be arrayed in a sequence different from those of the coolant supply 44 on the fuel cell vehicle 80, or only the fuel gas supply 40 and the oxygen-containing gas supply 42 may be switched around with the coolant supply 44 being arrayed in the same layout as those of the coolant supply 44 on the fuel cell vehicle 80. At any rate, the fuel cell system according to the second embodiment offers the same advantages as the fuel cell system according to the first second embodiment.

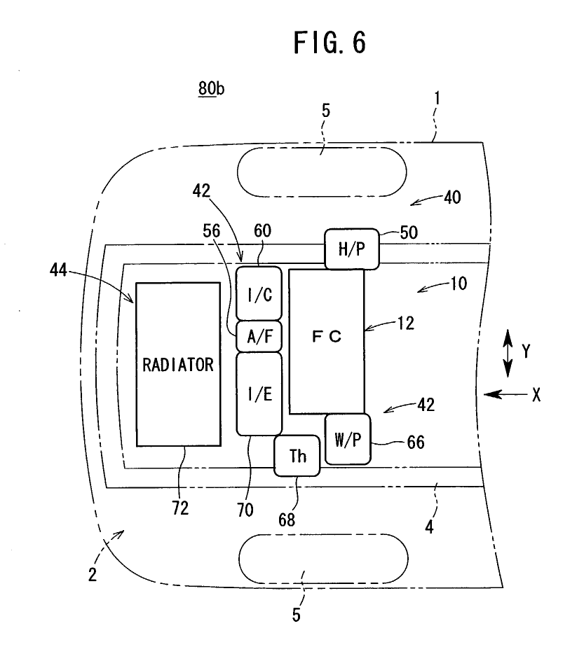

FIG. 6 schematically shows in plan a fuel cell vehicle 80b which incorporates a fuel cell system according to a third embodiment of the present invention.

In the fuel cell vehicle 80b, the intercooler 60 and the air filter 56 of the oxygen-containing gas supply 42 and the ion exchanger 70 of the coolant supply 44, which are arrayed successively from one end to the other of the fuel cell stack 12, are disposed between the fuel cell stack 12 and the radiator 72.

In the coolant supply 44, the coolant pump 66 and the thermostat 68 are disposed near the ion exchanger 70 and arranged successively from a position forward of the fuel cell stack 12 to the other end of the fuel cell stack 12. The fuel gas pump 50 is disposed near the one end of the fuel cell stack 12.

Alternatively, the intercooler 60, the thermostat 68, and the ion exchanger 70 may be disposed between the fuel cell stack 12 and the radiator 72. The air filter 56 and the fuel gas pump 50 may be disposed closely to the one end of the fuel cell stack 12, and the coolant pump 66 may be disposed closely to the other end of the fuel cell stack 12.

Further alternatively, the ion exchanger 70 and the intercooler 60 may be disposed between the fuel cell stack 12 and the radiator 72, and the other components may be disposed closely to the opposite ends of the fuel cell stack 12.

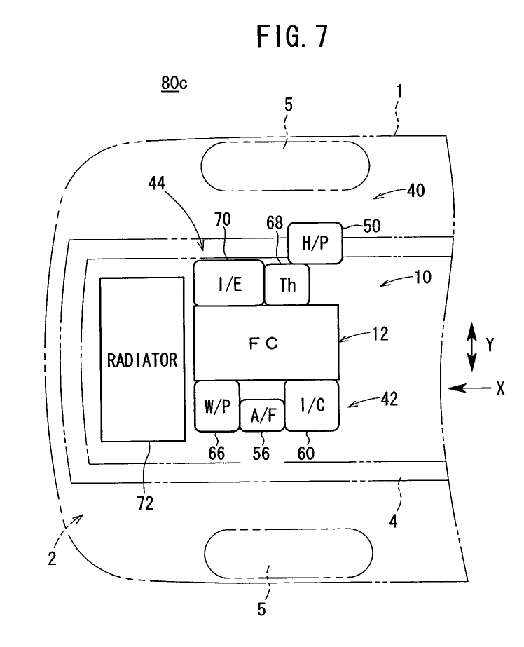

FIG. 7 schematically shows in plan a fuel cell vehicle 80c which incorporates a fuel cell system according to a fourth embodiment of the present invention.

In the first through third embodiments, the fuel cell stack 12 disposed in the front box 2 has its longitudinal axis oriented in the transverse direction (indicated by the arrow Y) of the vehicle. In the fuel cell vehicle 80c, the fuel cell stack 12 disposed in the front box 2 has its longitudinal axis oriented in the longitudinal direction (indicated by the arrow X) of the vehicle.

The ion exchanger 70, the thermostat 68, and the fuel gas pump 50 are disposed closely to one end of the fuel cell stack 12 in the transverse direction of the vehicle, and the other components are disposed closely to the other end of the fuel cell stack 12 in the transverse direction of the vehicle.

Alternatively, the air filter 56 and the intercooler 60 may be disposed closely to the one end of the fuel cell stack 12 in the transverse direction of the vehicle, and the coolant pump 66, the thermostat 68, the ion exchanger 70, and the fuel gas pump 50 may be disposed closely to the other end of the fuel cell stack 12 in the transverse direction of the vehicle.

Further alternatively, the intercooler 70 and the air filter 56 may be disposed closely to the other end of the fuel cell stack 12 in the transverse direction of the vehicle, and the other components may be disposed closely to the one end of the fuel cell stack 12 in the transverse direction of the vehicle.

Still further alternatively, the ion exchanger 70, the coolant pump 66, and the thermostat 68 may be disposed closely to the one end of the fuel cell stack 12 in the transverse direction of the vehicle, and the intercooler 60, the air filter 56, and the fuel gas pump 50 may be disposed closely to the other end of the fuel cell stack 12 in the transverse direction of the vehicle.

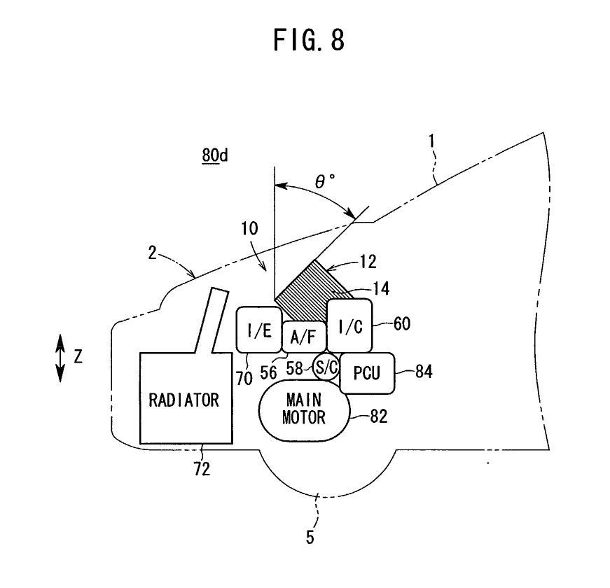

FIG. 8 schematically shows in side elevation a fuel cell vehicle 80d which incorporates a fuel cell system according to a fifth embodiment of the present invention.

In the fuel cell vehicle 80d, the fuel cell stack 12 disposed in the front box 2 is inclined at a predetermined angle θ° (e.g., 45°) to the vertical rearwardly with respect to the direction in which the fuel cell vehicle 80d is normally propelled. The side of the fuel cell stack 12 where the oxygen-containing gas discharge communication hole 32b is defined is positioned downwardly of the side of the fuel cell stack 12 where the oxygen-containing gas supply communication hole 32a is defined.

In the fuel cell vehicle 80d, therefore, water generated in the fuel cell stack 12 can flow smoothly down the inclined surfaces toward the oxygen-containing gas discharge communication hole 32b, and can effectively be discharged into the oxygen-containing gas discharge communication hole 32b.

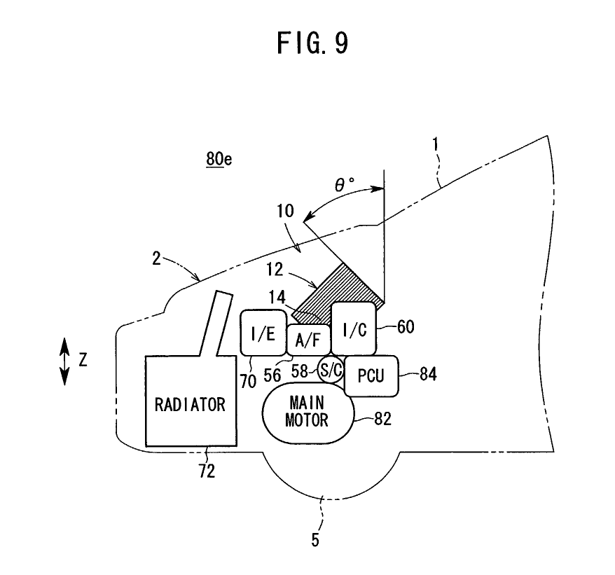

FIG. 9 schematically shows in side elevation a fuel cell vehicle 80e which incorporates a fuel cell system according to a sixth embodiment of the present invention.

In the fuel cell vehicle 80e, the fuel cell stack 12 disposed in the front box 2 is inclined at a predetermined angle θ° (e.g., 45°) to the vertical forwardly with respect to the direction in which the fuel cell vehicle 80e is normally propelled. The side of the fuel cell stack 12 where the oxygen-containing gas discharge communication hole 32b is defined is positioned downwardly of the side of the fuel cell stack 12 where the oxygen-containing gas supply communication hole 32a is defined. Therefore, water generated in the fuel cell stack 12 can effectively be discharged into the oxygen-containing gas discharge communication hole 32b.

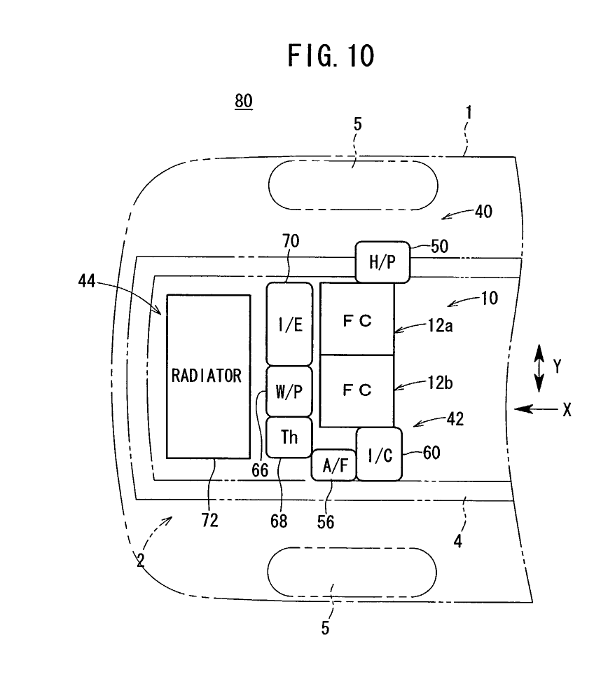

In the first through sixth embodiments, the fuel cell system has a single unitary fuel cell stack 12. However, as shown in FIG. 10, the fuel cell system may have two divided fuel cell stacks 12a, 12b mounted on the fuel cell vehicle 80 according to the first embodiment shown in FIG. 3. Alternatively, the fuel cell system may have three or more divided fuel cell stacks.

In the fuel cell system according to the present invention, the fuel cell stack comprising a vertical stack of unit cells, i.e., membrane electrode assemblies and separators, is disposed in the front box. If the number of stacked unit cells is increased for a higher output of the fuel cell stack, then the fuel cell stack increases its dimension only in the vertical direction.

Therefore, the fuel cell stack is not elongated in the longitudinal or transverse direction of the vehicle, and hence the full length or width of the vehicle is not changed when a higher output is to be produced from the fuel cell stack. The fuel cell stack can easily be arranged for a higher output, and various components can be placed in a neat layout in the front box.

Although certain preferred embodiments of the present invention have been shown and described in detail, it should be understood that various changes and modifications may be made therein without departing from the scope of the appended claims.

What is claimed is:

1. A fuel cell system housed in a front box of a vehicle, comprising:
a fuel cell stack having alternately stacked electrolyte electrode assemblies and separators, each of said electrolyte electrode assemblies comprising a pair of electrodes and an electrolyte disposed between said electrodes;
said fuel cell stack being disposed in said front box with said electrolyte electrode assemblies and said separators being stacked vertically.

2. A fuel cell system according to claim 1, further comprising:
a fuel gas supply accessory for supplying a fuel gas to said fuel cell stack, said fuel gas supply accessory being disposed on one side of said fuel cell stack with respect to a direction in which the vehicle is normally propelled.

3. A fuel cell system according to claim 2, further comprising:
an oxygen-containing gas supply accessory for supplying an oxygen-containing gas to said fuel cell stack, or a coolant supply accessory for supplying a coolant to said fuel cell stack, said oxygen-containing gas supply accessory or said coolant supply accessory being disposed on the other side of said fuel cell stack with respect to the direction in which the vehicle is normally propelled.

4. A fuel cell system according to claim 1, further comprising:
a radiator disposed in said front box at a front end thereof with respect to a direction in which the vehicle is normally propelled; and
a coolant supply accessory for supplying a coolant to said fuel cell stack, said coolant supply accessory being disposed between said radiator and said fuel cell stack.

5. A fuel cell system according to claim 4, further comprising:
a fuel gas supply accessory for supplying a fuel gas to said fuel cell stack, said fuel gas supply accessory being disposed on one side of said fuel cell stack with respect to said direction in which the vehicle is normally propelled.

6. A fuel cell system according to claim 5, further comprising:
an oxygen-containing gas supply accessory for supplying an oxygen-containing gas to said fuel cell stack, or a coolant supply accessory for supplying a coolant to said fuel cell stack, said oxygen-containing gas supply accessory or said coolant supply accessory being disposed on the other side of said fuel cell stack with respect to the direction in which the vehicle is normally propelled.

7. A fuel cell system according to claim 1, wherein said fuel cell stack has a longitudinal axis oriented in a longitudinal direction of the vehicle, further comprising:
a fuel gas supply accessory for supplying a fuel gas to said fuel cell stack, said fuel gas supply accessory being disposed on one end of said fuel cell stack in a transverse direction of said vehicle; and
an oxygen-containing gas supply accessory for supplying an oxygen-containing gas to said fuel cell stack, said oxygen-containing gas supply accessory being disposed on the other end of said fuel cell stack in the transverse direction of said vehicle.

8. A fuel cell system according to claim 7, further comprising:
coolant supply accessories for supplying a coolant to said fuel cell stack, said coolant supply accessories being disposed on the opposite ends of said fuel cell stack in the transverse direction of said vehicle.

9. A fuel cell system housed in a front box of a vehicle, comprising:
a fuel cell stack having alternately stacked electrolyte electrode assemblies and separators, each of said electrolyte electrode assemblies comprising a pair of electrodes and an electrolyte disposed between said electrodes;
said fuel cell stack being disposed in said front box with said electrolyte electrode assemblies and said separators stacked upright and inclined forward or rearward with respect to a direction in which the vehicle is normally propelled.
